(19) United States
(12) Patent Application Publication
(10) Pub. No.: US 2013/0045299 A1
(43) Pub. Date: Feb. 21, 2013

(54) Natural Mold Inhibitor and Methods of Using Same

(71) Applicants: Paul Bright, Fenton, MO (US); Craig Baumer, St. Louis, MO (US); William McKeown, Wildwood, MO (US); Clifford Jackson, Ormond Beach, FL (US)

(72) Inventors: Paul Bright, Fenton, MO (US); Craig Baumer, St. Louis, MO (US); William McKeown, Wildwood, MO (US); Clifford Jackson, Ormond Beach, FL (US)

(21) Appl. No.: 13/584,200

(22) Filed: Aug. 13, 2012

Related U.S. Application Data
(60) Provisional application No. 61/523,686, filed on Aug. 15, 2011.

(51) Int. Cl. A21D 15/00; A01N 37/36; A01P 3/00; A01N 37/04

(52) U.S. Cl. 426/9; 514/574

(57) ABSTRACT

Disclosed herein are compositions containing natural acids and natural buffering agents useful for inhibiting mold growth and/or prolonging the shelf life of baked products, which do not require propionic acid, and may be in either a liquid or a dry form. Also disclosed are methods of using the disclosed compositions.

### CROSS-REFERENCE TO RELATED APPLICATIONS

This application claims priority to U.S. Provisional Application Ser. No. 61/523,686, filed Aug. 15, 2011.

### BACKGROUND

Baked good microbial spoilage and the corresponding loss of saleable product is a major issue facing the baking industry, causing millions of dollars in product losses per year. Due to advancements in enzyme technology in recent years, fresh keeping qualities (softness, reduction in staleness) of baked goods have increased the saleable shelf life of these baked goods from a period of days to weeks. Microbial spoilage has now become the limiting factor as to how long a baked good can remain edible.

During the baking process high heat environment, baked goods are essentially free from any microbial contamination; however, once the baked good exits the oven and starts to cool, the main source of microbial contamination comes from air-born mold spores and through contact with contaminated production equipment, (conveyors and slicers). Baked products have a relatively fast microbial spoilage rate, specifically due to mold spoilage because of the types of ingredients used, the relatively high water activity of the finished product (>0.90 Aw), and the average finished product having a pH of between 5-6.

For “yeast raised” baked goods the baking industry traditionally relies on microbial preservatives that are based on an organic acid, propionic acid, and its related salt compounds. These propionic acid based anti-microbial compounds can be both chemically and naturally derived. The chemically derived anti-microbials frequently used by the baking industry are calcium propionate and sodium propionate. Naturally derived anti-microbial preservatives that contain propionic acid are typically produced by bacterial fermentations of differing substrates such as cultured wheat, cultured wheat starch, cultured corn syrup solids, and/or cultured whey.

Although the use of anti-microbial compounds that are based on propionates as the functional component are effective at slowing down mold growth in baked goods, the consumer and baking industry have been advocating for the development of natural, label friendly preservatives that do not rely on propionic acid or propionate salts as their functional components. There are few natural bread mold inhibitor solutions currently offered in the baking industry that are effective in yeast raised, baked products and that do not rely on propionic acid or its salt version as the functional anti-microbial mold inhibition component. Due to the current customer demand for natural, label friendly ingredients, the baking industry has been attempting to develop a natural mold inhibitor that does not use propionic acid or its salt as its functional component.

Currently, synthetic preservatives such as calcium propionate and natural preservative solutions such as cultured wheat flour/corn syrup (microbially produced propionic acid systems) are used to inhibit mold and to increase bread shelf life in the baking industry. These products currently used all contain propionic acid and/or its salt as the effective anti-microbial component of the system. There are no current effective mold inhibition systems for yeast raised baked products that do not utilize propionic acid or its salt.

Organic acids (vinegar/acetic acid, lactic acid, citric acid) are also used in the baking industry as anti-microbial mold inhibitors. However, when used by themselves, at effective anti-microbial usage levels, the pH of the baked bread is lowered considerably. As a consequence, the low pH of the bread produces an acidic flavor that is not palatable nor desirable.

A secondary consequence of the use of high levels of organic acids to inhibit mold growth in bread is the requirement or usage of high levels of yeast. Yeast levels in formulations are often increased by two to three time due to the inhibitory effect of organic acid on yeast activity.

A tertiary effect of using high organic acid levels in bakery products to inhibit mold growth is the overall negative effect on the rheology of the dough during processing and the consequent lowering of quality in the final end baked product. Excessive organic acid addition to dough systems to inhibit mold growth will cause the protein matrix to weaken, causing processing issues at the bakery as well as with the baked bread. Bread that is baked with dough that is low in pH will typically exhibit lower volumes, open/coarse cell structure, poor overall quality. Because of these occurrences, the baking industry does not use high levels of organic acids as stand-alone preservation systems, but rather, typically uses them only in conjunction with a propionic acid based mold inhibitor to obtain the desired mold free shelf life.

Other organic acids commonly found in the baking industry to retard mold growth include, for example, acetic acid, lactic acid and citric acid. One of ordinary skill in the art will appreciate that these organic acids, when used at functional levels, will have a strong negative effect on the processing, end-baked product quality and palatability of the baked product. First, the amount of the organic acid required to be effective as mold inhibitors will cause the baked product to be unpalatable due to the strong acidic flavor. These attributes lead to diminished consumer acceptance. Second, at the effective mold inhibition usage levels, the organic acids will negatively affect yeast activity, causing excessively long proof times and small baked volumes. Third, the high acidic, low pH environment of the dough system will cause proteins of the dough to break down leading to poor gas retention, inferior crumb structure, poor external symmetry and lower baked volume products. Processing of the dough at the bakeries will also be negatively affected due to the increased stickiness of the dough caused by the weakened proteins.

Examples of other non-propionate based preservatives used in the baking industry include sorbates, benzoates and natamycin; however, these preservatives have disadvantages when used in “yeast raised” bakery applications. First, these agents have strong inhibitory effects on yeast activity when used at effective usage rates. Inhibitory effects on yeast activity will cause excessively long proof times, and small overall baked product volumes. Second, these preservatives will have a negative effect on the dough rheology strength, and as a consequence cause poor overall gas retention in the dough system. This diminished dough strength will lead to small product volume, poor external baked symmetry, and poor internal crumb structure. All of these attributes will lead to diminished consumer acceptance.

Thus, there is an unmet need for compositions and methods for extending the shelf life of bread products which avoid the aforementioned negative effects on processing and baked product quality.

### BRIEF SUMMARY

Disclosed herein are compositions containing natural acids and natural buffering agents useful for inhibiting mold growth and/or prolonging the shelf life of baked products, which do not require propionic acid, and may be in either a liquid or a dry form. Also disclosed are methods of using the disclosed compositions.

### BRIEF DESCRIPTION OF THE DRAWING

FIG. 1 depicts a graph of days to mold and bread pH for breads containing compositions comprising vinegar and citric acid and lactic acid.

FIG. 2 depicts a graph showing days to mold and bread pH for control bread, bread containing calcium propionate; cultured corn syrup and citric acid (Nabitor™); and liquid natural mold inhibitor formulations as disclosed herein.

FIG. 3 depicts days to mold and bread pH for control bread, bread containing calcium propionate, and liquid natural mold inhibitor formulations as disclosed herein.

FIG. 4 depicts days to mold and bread pH for control bread, bread containing calcium propionate, or dry natural mold inhibitors as disclosed herein.

FIG. 5 depicts days to mold and proof time for control bread and bread containing liquid and dry natural mold inhibitor formulations as disclosed herein.

### DETAILED DESCRIPTION

The present development may be understood more readily by reference to the following detailed description of preferred embodiments and the Examples included therein and to the Figures and their previous and following description. Although any methods and materials similar or equivalent to those described herein can be used in the practice or testing of the methods and composition, exemplary methods, devices, and materials are now described. All references, publications, patents, patent applications, and commercial materials mentioned herein are incorporated herein by reference for the purpose of describing and disclosing the materials and/or methodologies which are reported in the publications which might be used in connection with the methods and composition.

As used herein, the terms “comprising”, “containing”, “having” and “including” are used in their open, non-limiting sense.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the term “natural” as defined herein means minimally processed and containing no synthetic ingredients or processing aids in accordance with the FDA guidelines (Food Labeling: Nutrient Content Claims General Principles, Petitions, Definition of Terms, 56 Fed. Reg. at 60,466). Natural ingredients, as used herein, may be organic ingredients.

Disclosed herein are compositions and methods relating to extending the mold free shelf life of baked goods using natural products and without the use of propionic acid or its related salts and which extend the mold free shelf life of baked goods without affecting the processing or product quality attributes.

The elements or features of the various embodiments are described in detail hereinafter.

In one aspect, the disclosed composition may be obtained by the reaction of natural organic acids with natural buffering agents, to arrive at a final composition, which may take the form of a powder or solution. In other aspects, by controlling the final pH of the natural mold inhibition compositions disclosed herein, the baked goods can be optimally processed at the bakery to extend shelf life while remaining palatable to the customer.

### Liquid Compositions

In one aspect, liquid compositions for inhibiting mold growth on a baked product are disclosed. In this aspect, the compositions may comprise from about 50% to about 95%, or about 80% to about 90%, or about 85% by weight of a natural acid, wherein the natural acid may be provided in a solution of from about 0.1% to about 99%, or from about 4% to about 40%, or from about 10% to about 20%, or any combination thereof, and from about 5% to about 80% by weight, or about 9% to about 16% of a buffering agent. In one aspect, the natural acid may be selected from acetic acid, lactic acid, citric acid, malic acid, tartaric acid, any other natural acid, or a combination thereof. In further aspects, the natural acid may be selected from vinegar, naturally derived acetic acid, or a combination thereof. The natural acid may be bacterially cultured, naturally derived, or a combination thereof.

In one aspect, the buffering agent may be selected from a natural calcium or sodium source. The buffering agent may be selected from sodium carbonate, sodium bicarbonate, calcium hydroxide, calcium carbonate, any other natural buffering agent, or a combination thereof.

In one aspect, the buffering agent may maintain the pH of said composition at a pH of from about 4.0 to about 5.5, or about 4.5 to about 5.3, or about 4.8 to about 5.2. In some aspects, the buffering agent may be calcium based and substantially free of sodium. In other aspects, the liquid composition may be substantially free of sodium or may comprise sodium.

In one aspect, the liquid is substantially free of propionic acid or a salt of propionic acid, and/or does not cause formation of propionic acid or a salt of propionic acid during a baking process.

In one aspect, the natural acid may comprise 100 grain vinegar and may be present in the liquid composition in an amount of from about 75% to about 95% by weight of said liquid composition, or about 85% of the composition, and the buffering agent may comprise of sodium bicarbonate and may be present in the liquid composition in an amount from about 5% to about 15%, or about 8.5% by weight of said liquid composition.

In one aspect, the natural acid may comprise 200 grain vinegar, and the natural acid may be present in the liquid composition in an amount of from about 80% to about 85% by volume, or about 84% by volume of said liquid composition, and the buffering agent may comprise sodium bicarbonate and may be present in the liquid composition in an amount of from about 10% to about 20% by volume, or about 15% to about 18%, or about 16% of the composition.

In a further aspect, the natural acid may comprise 300 grain vinegar and may be present in the liquid composition in an amount of from about 60% to about 90% by volume of said liquid composition, or about 70% of the composition, and the buffering agent may comprise sodium bicarbonate and may be present in the liquid composition in an amount of from about 20% to about 50%, or about 30%, by volume of said liquid composition.

The above liquid composition may be manufactured using methods known to one of ordinary skill in the art. In one aspect, the liquid mold inhibitor may be manufactured by combining the natural acid and buffering agent to form a mixture, followed by agitating and heating the mixture. The mixture may be heated to a temperature of from about 40° F. to about 200° F., or about 100° F. to about 120° F., or about 110° F. The heating step may be carried out for a time of from about 10 minutes to about 24 hours, or from about 20 minutes to about 45 minutes, or from about 25 minutes to about 35 minutes, or about 30 minutes, or until the pH of the mixture is from about 4.0 to about 5.5, or about 4.2 to about 5.3, or about 4.5 to about 5.2.

### Dry Compositions

A dry composition for inhibiting mold growth on a baked product is also disclosed herein. In this aspect, the composition may comprise a first component comprising from about 70% to about 95%, or from about 78 to about 89%, or about 85%, of a natural acid, wherein the natural acid may be provided in a solution of from about 0.1% to about 99%; and from about 5% to about 30%, or about 11% (for example, where a calcium based buffering agent is used) to about 22% (for example where a sodium based buffering agent is used) of a buffering agent; and a second component that may comprise from about 20% to about 50%, or about 30% to about 40%, or about 25% of an acid selected from citric acid, malic acid, tartaric acid, lactic acid, any other natural acid, or a combination thereof.

In one aspect, the natural acid may be selected from acetic acid, lactic acid, citric acid, malic acid, tartaric acid, any other natural acid, or a combination thereof. In other aspects, the natural acid may be selected from vinegar, naturally derived acetic acid, or a combination thereof. The natural acid may be bacterially cultured, derived from natural sources, or a combination thereof.

In one aspect, the buffering agent may be selected from a natural calcium or sodium source. The buffering agent may be selected from sodium bicarbonate, calcium hydroxide, calcium carbonate, any other natural buffering agent, or a combination thereof.

In one aspect, the buffering agent may maintain the pH of said composition at a pH of from about 4.0 to about 5.5, or about 4.5 to about 5.3, or about 4.8 to about 5.2. In some aspects, the buffering agent may be calcium based and substantially free of sodium. In other aspects, the liquid composition may be substantially free of sodium or may comprise sodium.

In one aspect, the liquid is substantially free of propionic acid or a salt of propionic acid, and/or does not cause formation of propionic acid or a salt of propionic acid during a baking process.

In one aspect, the natural acid may comprise 100 grain vinegar in an amount of from about 80% to about 95%, or about 85%, or about 95% of the first component, and the buffering agent may be present in the amount of from about 4% to about 20% or from about 5%, or about 8% or about 16% by weight of the first component.

In one aspect, the first component may comprise 200 grain vinegar in an amount of about from 80% to about 85%, or about 84% by volume of the first component, and the buffering agent may be present in an amount of from about 10% to about 20%, or from about 15%, or about 18%, or about 16% by volume of the first component.

In another aspect, the first component may comprise 300 grain vinegar in an amount of from about 60% to about 90%, or from about 70% of the first component, and the buffering agent may comprise sodium bicarbonate be present in an amount of from about 20% to about 50%, or about 30% of the first component.

The second component may comprise a liquid, an agglomerate, encapsulate, paste, gel, extrudate, or a combination thereof. In other aspects, the dry composition may be a semi solid, for example, a gel or a paste. The dry composition may be in a form selected from a powder, a granule, a pellet, or a mixture thereof. In one aspect, the composition may comprise less than about 10% moisture, or less than about 9% moisture, or less than about 8% moisture, or less than about 7% moisture, or less than about 6% moisture, or less than about 5% moisture, or less than about 4% moisture, or less than about 3% moisture, or less than about 2% moisture, or less than about 1% moisture.

The dry natural mold inhibitors may be prepared using methods known in the art. For example, in one aspect, a dry natural mold inhibitor as described herein may be manufactured by combining a buffer with a natural acid to form a mixture; allowing the mixture to react and form a solution comprising solids, and drying the solution comprising solids to form a dry mixture comprising less than about 10% water. This may then be combined with a natural acid as disclosed herein. The drying step may be carried out via any method known in the art, including, but not limited to spray drying, drum drying, flash drying, or a combination thereof. In one aspect, the composition may contain from about 10% to about 40% total solids.

### Methods

Also disclosed are methods of inhibiting mold growth on a baked good. In this aspect, the method may comprise the steps of combining a composition as disclosed herein with at least one, or at least two, or at least three, or at least four or more ingredients selected from a wheat flour, water, salt, leavening system (biological and/or chemical), sugar, or a combination thereof to form a raw bakery dough or batter. The method may further comprise the step of baking the bakery dough or batter system. In one aspect, the baked good, after baking, may have a pH of from about 4.5 to about 7.0, or about 5 to about 6.0, or from about 5 to about 5.5, or from about 5 to about 5.2. In one aspect, the bakery dough or batter may be that of bread, rolls, buns, steam buns, pizza dough, English muffin dough, tortillas, pita, doughnuts, cakes or any other baked product.

The bakery dough or batter system may comprise a starch, or, in other aspects, may be a starch based dough. The starch may be derived from a grain such as, for example, a starch derived from wheat, white rice, garbanzo bean, potato, quinoa, amaranth, arrowroot, barley, brown rice, buckwheat, chia, corn, cornmeal, hemp, maize, oat, rye, sorghum, soya, tapioca, teff, or a combination thereof. In other aspects, the bakery dough or batter may be a gluten-free.

In one aspect, the bakery dough may be processed via methods known in the art, including methods such as no-time/straight dough, sponge and dough, flour brew, water brew, frozen dough, any other baked product process, or a combination thereof. The baked good may be free of, or substantially free of, propionic acid or a salt of propionic acid.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Any reference to a singular characteristic or limitation of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The compositions and methods may comprise, consist of, or consist essentially of the elements and features of the disclosure described herein, as well as any additional or optional ingredients, components, or features described herein or otherwise useful in a application.

All numerical ranges as used herein, whether or not expressly preceded by the term “about”, are intended and understood to be preceded by that term, unless otherwise specified.

### EXAMPLES

The following examples provide data and/or illustrate specific embodiments and/or features of the nutritional compositions and methods of the present disclosure. The examples are given solely for the purpose of illustration and are not to be construed as limitations, as many variations thereof are possible without departing from the spirit and scope of the disclosure.

### Example 1

### Manufacture of Solid Mold Inhibitor

11-22 grams of sodium bicarbonate or calcium hydroxide is combined with 78-89.0 grams of 200 grain liquid vinegar. The liquid mixture is then agitated by an agitator and heated to a temperature of about 110 F for 30 minutes to form a solution of solids with a solids level of from about 10% to about 40% total solids. The solution is then processed to remove water to achieve less than about 10% moisture. Removal of water may be achieved using a spray dryer, though other methods known in the art may be used. The dry material is then combined with a natural organic acid such as citric acid at a ratio of about 70% dry material to about 30% acid. The final material is blended and then packaged.

### Example 2

### Manufacture of Liquid Mold Inhibitor

9-16 grams of sodium bicarbonate or calcium hydroxide are combined with 83-91 grams of vinegar having a strength of about 200 to about 300 grain. The liquid mixture is then agitated using an agitator and heated to a temperature of about 110 F for 30 minutes. Following agitation with heating, the pH is checked and is from about pH 4.0 to about pH 5.5. The material is then packaged.

TABLE 1
Dry Mold Inhibitor Formulations (Amounts provided as
weight %)

| Ingredient | Ex 3 | Ex 4 | Ex 5 | Ex 6 | Ex 7 | Ex 8 | Ex 9 | Ex 10 |
|---|---|---|---|---|---|---|---|---|
| Sodium | 15.0 | | 16.5 | | 25 | | 27.5 | |
| Bicarbonate¹ | | | | | | | | |
| Calcium | | 7.7 | | 8.25 | | 17 | | 19 |
| hydroxide² | | | | | | | | |
| Vinegar, 200 | 55.0 | 62.3 | 58.5 | 66.75 | | | | |
| grain³ | | | | | | | | |
| Vinegar, 300 | | | | | 45 | 53 | 47.5 | 56 |
| grain⁴ | | | | | | | | |
| Citric acid⁵ | 30 | 30 | 25 | 25 | 30 | 30 | 25 | 25 |

TABLE 2
Liquid Mold Inhibitor Formulations (Amounts provided as weight %)

| Ingredient | Ex 11 | Ex 12 | Ex 13 | Ex 14 |
|---|---|---|---|---|
| Sodium | 16 | | 16 | |
| Bicarbonate¹ | | | | |
| Calcium | | 9.25 | | 9.25 |
| hydroxide² | | | | |
| Vinegar, 200 | 83.95 | 90.7 | | |
| grain³ | | | | |
| Vinegar, 300 | | | 55.95 | 59.95 |
| grain⁴ | | | | |
| Cultured | 0.05 | 0.05 | 0.05 | 0.05 |
| Wheat⁶ | | | | |
| Water | 28 | 30.75 | | |

¹Commercially available from Vitusa Products, Inc
²Commercially available from Mississippi Lime Company
³Commercially available from Fleischmann's Vinegar Company, Inc.
⁴Commercially available from Fleischmann's Vinegar Company, Inc
⁵Commercially available from Univar USA, Inc
⁶Commercially available from Kerry, Inc.

### Example 15

Bread is prepared using the no-time, straight dough method by mixing the following ingredients in a Hobart A200 mixer with a McDuffy attachment for a total of 8 minutes until full gluten development is obtained: flour (100%), water (68%), granulated sugar (7%), shortening (4%), fresh yeast (2.5%), 30% acetic acid vinegar or 300 grain vinegar (0%, 2%, 1% or 0.5%), and citric acid (0% or 0.1%). Mixed dough is rested for 10 minutes on bench then scaled into two 520 gram dough pieces and rounded by hand. Rounded dough is rested 10 minutes then is sheeted and molded into logs. Sheeted and molded logs are placed into oiled bread pans and placed into proof box (National Manufacturing) and set to 110° F. and 80% relative humidity. Dough is proofed to a consistent height, as measured by a template which was 0.75 inches above the rim of the bread pan. Proof time is considered to be time for dough to touch the top of the template minus initial time in the proof box. Proofed dough is then placed into an oven and baked for 20 minutes at a temperature of 420° F. Internal temperature of the bread exiting the oven is 195° F.-200° F. Baked bread is cooled at room temperature on a wire rack for one hour to an internal temperature of between 95° F. and 100° F. After cooling, bread is sliced and packaged in plastic bags and sealed with twist ties. Packaged bread is stored at room temperature 70° F.-75° F. and visually inspected for mold appearance on a daily basis. Bread is considered as expired/failed upon first sign of mold.

Results from experiments carried out as above are shown in Table 3. Control bread with no preservatives failed at 8 days. High levels of 300 grain vinegar, 30% acetic acid (2%) had a mold inhibiting effect with the bread failing at 20 days of storage. However, time to proof increased to an unacceptable 119 minutes from a control proof time of 47 minutes. Bread pH of the high level of 300 grain vinegar (2%) was 4.4 as compared to the control bread with no preservatives, which was 5.77. The flavor of the high level of 300 grain vinegar (2%) was considered to be sour and unpalatable to eat. Only when the 300 grain vinegar level was reduced to (0.5%) was the proof time similar to the control (no preservatives) and the bread considered palatable to eat. However, at this usage rate, there was no improvement in mold inhibition as compared to the control without preservatives. Both breads molded at 8 days.

TABLE 3
Mold-free shelf life of breads containing natural organic acids

| | Days To | Bread | Proof |
|---|---|---|---|
| Sample | Mold | pH | Time |
| Control—No Preservatives | 8 | 5.77 | 47 |
| Vinegar-300 grain (2%) | 20 | 4.4 | 119 |
| Vinegar-300 grain (1%) | 12 | 4.65 | 47 |
| Vinegar-300 grain (0.5%) | 8 | 4.99 | 47 |
| Vinegar-300 grain (2%) + | 12 | 4.33 | 138 |
| Citric Acid (0.1%) | | | |

### Example 16

Bread is prepared using the no-time, straight dough method by mixing the following ingredients in a Hobart A200 mixer with a McDuffy attachment for a total of 8 minutes until full gluten development was obtained: flour (100%), water (68%), granulated sugar (7%), shortening (4%), fresh yeast (2.5%), with variables being liquid propionic acid free natural mold inhibitor (4%, 3%, 2.5%, 2%, 1%), calcium propionate (0.33%, 0.5%) and a control dough without any preservatives added. Mixed dough is rested for 10 minutes on bench then scaled into two 520 gram dough pieces and rounded by hand. Rounded dough is rested 10 minutes then sheeted and molded into logs. Sheeted and molded logs are placed into oiled bread pans and placed into proof box (National Manufacturing) set to 110° F. and 80% relative humidity. Dough is proofed to a consistent height, as measured by a template which was 0.75 inches above the rim of the bread pan. Proof time is considered to be time for dough to touch the top of the template minus initial time in the proof box. Proofed dough is then placed into an oven and is baked for 20 minutes at a temperature of 420° F. The internal temperature of the bread exiting the oven is 195° F.-200° F. Baked bread is cooled at room temperature on a wire rack for one hour to an internal temperature of between 95° F. and 100° F. After cooling, the bread is sliced and packaged in plastic bags and sealed with twist ties.

Packaged bread is stored at room temperature 70° F.-75° F. Packaged bread is visually inspected for mold appearance on a daily basis. Bread is considered as expired/failed upon first sign of mold. Results are shown in Table 4.

TABLE 4
Days to mold, pH, and proof time for bread products
containing calcium propionate, or the liquid natural mold
inhibitor disclosed herein, in comparison with a control
sample containing no preservatives.

| | Days to | | Proof Time |
|---|---|---|---|
| Sample | Mold | pH Bread | (min.) |
| Control—No Additives | 8 | 5.91 | 56 |
| Calcium Propionate (0.33%) | 15 | 5.60 | 53 |
| Calcium Propionate (0.5%) | 17 | 5.45 | 63 |
| Liquid Natural Mold Inhibitor (4%) | >40 | 5.18 | 49 |
| Liquid Natural Mold Inhibitor (3%) | 36 | 5.26 | 48 |
| Liquid Natural Mold Inhibitor (2.5%) | 14 | 5.33 | 48 |
| Liquid Natural Mold Inhibitor (2%) | 11 | 5.36 | 47 |
| Liquid Natural Mold Inhibitor (1%) | 9 | 5.56 | 47 |

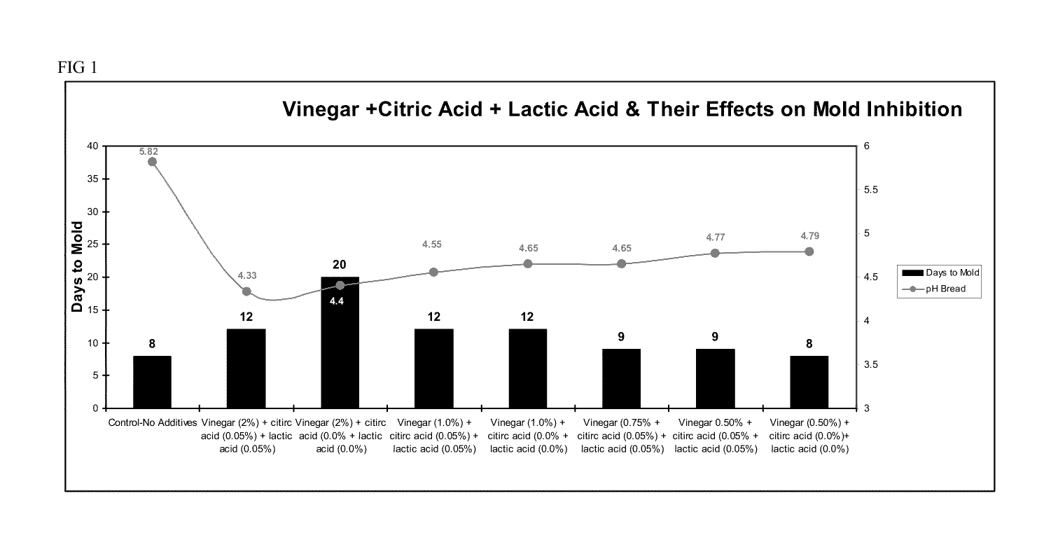

TABLE 5
Data shown in FIG. 1. FIG. 1 illustrates the effects of added
organic acids (non-propionic acid based) on white pan bread mold
inhibition and pH. The data demonstrates that, the use of organic acids
vinegar, citric and lactic acid can be effective as mold inhibitors.
However, when organic acids are used at effective levels to inhibit
mold growth in baked products, the pH of the baked product may be
reduced to a level where the baked good becomes unpalatable. Baked
products that have a pH lower than 5 are considered sour/tart and are
not typical of a standard baked product.

| | Days to | pH | Proof |
|---|---|---|---|
| Sample | Mold | Bread | Time |
| Control—No Additives | 8 | 5.82 | 45 |
| Vinegar (2%) + citric acid (0.05%) + lactic | 12 | 4.33 | 138 |
| acid (0.05%) | | | |
| Vinegar (2%) + citric acid (0.0%) + lactic | 20 | 4.4 | 119 |
| acid (0.0%) | | | |
| Vinegar (1.0%) + citric acid (0.05%) + lactic | 12 | 4.55 | 48 |
| acid (0.05%) | | | |
| Vinegar (1.0%) + citric acid (0.0%) + lactic | 12 | 4.65 | 47 |
| acid (0.0%) | | | |
| Vinegar (0.75% + citric acid (0.05%) + lactic | 9 | 4.65 | 43 |
| acid (0.05%) | | | |
| Vinegar 0.50% + citric acid (0.05% + lactic | 9 | 4.77 | 45 |
| acid (0.05%) | | | |
| Vinegar (0.50%) + citric acid (0.0%) + lactic | 8 | 4.79 | 47 |
| acid (0.0%) | | | |

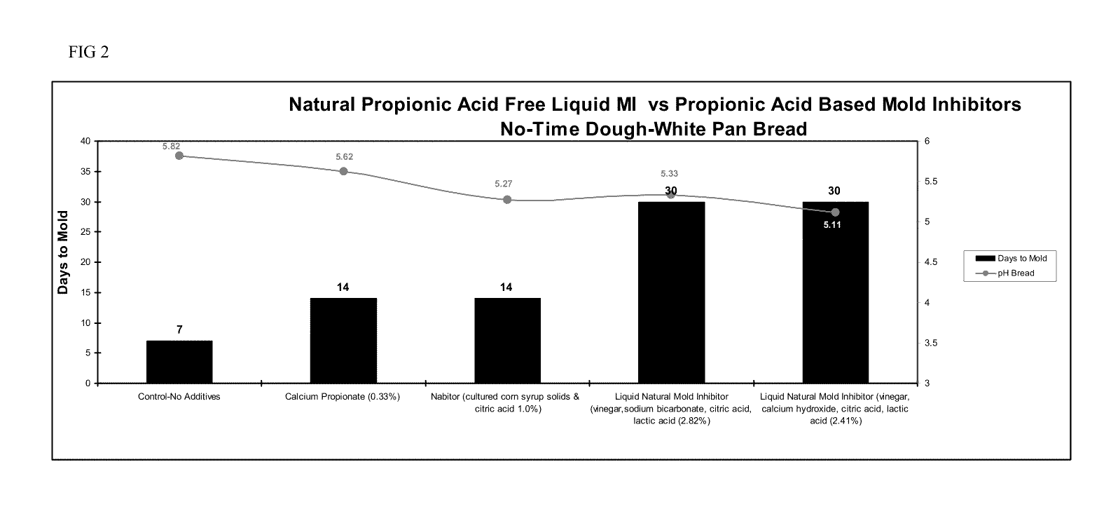

TABLE 6
Data shown in FIG. 2 FIG. 2 illustrates the antimicrobial
effects of non-propionic acid based Liquid Natural Mold Inhibitors and
traditional propionate acid based mold inhibitors, calcium propionate
and Nabitor ™ (an anti-microbial product available from AB Mauri)
used in white pan bread. Nabitor ™ is a blend of naturally cultured
corn syrup solids, that contains propionic acid as a byproduct of
fermentation & citric acid. The data illustrates that the Natural Mold
Inhibitors produced with sodium bicarbonate and calcium hydroxide
are as effective in inhibiting the rate of mold growth as compared to
the industry standard propionic acid based mold inhibitors.

| | Days to | pH |
|---|---|---|
| Sample | Mold | Bread |
| Control—No Additives | 7 | 5.82 |
| Calcium Propionate (0.33%) | 14 | 5.62 |
| Nabitor ™ (cultured corn syrup | 14 | 5.27 |
| solids & citric acid 1.0%) | | |
| Liquid Natural Mold Inhibitor (vinegar, sodium | 30 | 5.33 |
| bicarbonate, citric acid, lactic acid (2.82%) | | |
| Liquid Natural Mold Inhibitor (vinegar, calcium | 30 | 5.11 |
| hydroxide, citric acid, lactic acid (2.41%) | | |

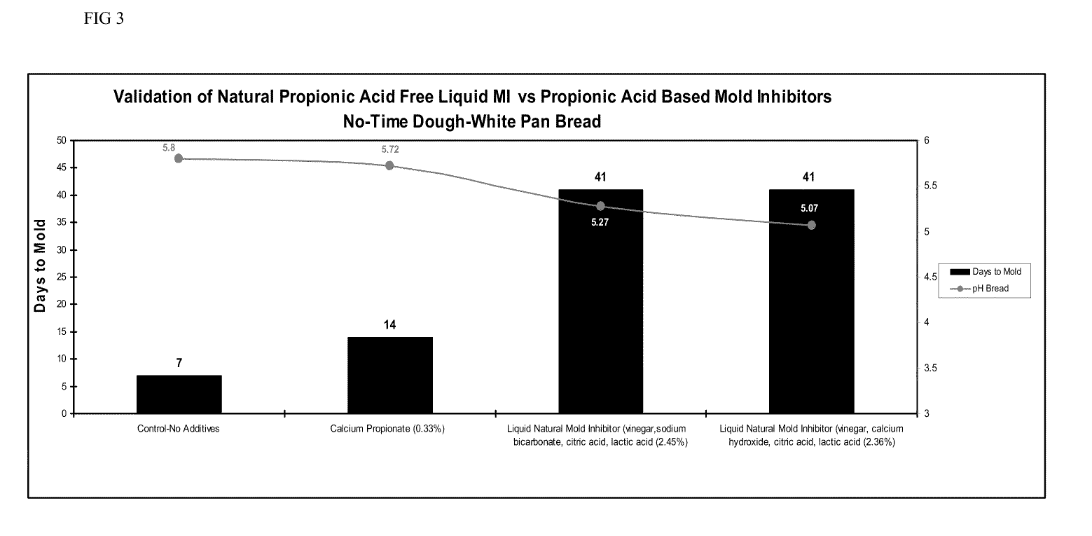

TABLE 7
Data shown in FIG. 3 FIG. 3 is a validation of previous
results comparing the antimicrobial effects of non-propionic acid based
Liquid Natural Mold Inhibitors and traditional propionate acid based
mold inhibitors, calcium propionate used in white pan bread. The data
illustrates that the Natural Mold Inhibitors produced with sodium
bicarbonate and calcium hydroxide are as effective in inhibiting the
rate of mold growth as compared to the industry standard propionic
acid based mold inhibitors.

| | Days to | pH |
|---|---|---|
| Sample | Mold | Bread |
| Control—No Additives | 7 | 5.8 |
| Calcium Propionate (0.33%) | 14 | 5.72 |
| Liquid Natural Mold Inhibitor (vinegar, sodium | 41 | 5.28 |
| bicarbonate, citric acid, lactic acid (2.45%) | | |
| Liquid Natural Mold Inhibitor (vinegar, calcium | 41 | 5.07 |
| hydroxide, citric acid, lactic acid (2.36%) | | |

TABLE 8
Table 8 illustrates the anti-microbial effects of various levels of dried
propionic acid free natural mold inhibitors (sodium and calcium based mold
inhibitors), compared to calcium propionate and natural cultured,
propionic acid based natural mold inhibitors (Nabitor ™, available from AB
Mauri). Days to mold data illustrates that both the calcium hydroxide and
sodium bicarbonate versions of the dried natural mold inhibitors are effective
as mold inhibitors. As usage levels are increased from 0.33% (flour basis)
to 1.50% (flour basis) there is a corresponding increase in days to mold
found in the bread products. When the dried natural mold inhibitor is used
at 1.50% there was a similar mold inhibiting effect to the use of calcium
propionate used at 0.50% (flour basis) and Nabitor ™ used at 1.00% (flour
basis).

| | Days to | pH |
|---|---|---|
| Sample | Mold | Bread |
| Dry Natural MI-321 (vinegar, calcium hydroxide, | 7 | 5.65 |
| citric acid, lactic acid, 0.33%) | | |
| Dry Natural MI-321 (vinegar, calcium hydroxide, | 8 | 5.6 |
| citric acid, lactic acid, 0.50%) | | |
| Dry Natural MI-321 (vinegar, calcium hydroxide, | 8 | 5.56 |
| citric acid, lactic acid, 0.75%) | | |
| Dry Natural MI-321 (vinegar, calcium hydroxide, | 9 | 5.58 |
| citric acid, lactic acid, 1.00%) | | |
| Dry Natural MI-321 (vinegar, calcium hydroxide, | 10 | 5.57 |
| citric acid, lactic acid, 1.25%) | | |
| Dry Natural MI-321 (vinegar, calcium hydroxide, | 12 | 5.57 |
| citric acid, lactic acid, 1.5%) | | |
| Dry Natural MI-322 (vinegar, sodium bicarbonate, | 7 | 5.54 |
| citric acid, lactic acid, 0.33%) | | |
| Dry Natural MI-322 (vinegar, sodium bicarbonate, | 8 | 5.54 |
| citric acid, lactic acid, 0.50%) | | |
| Dry Natural MI-322 (vinegar, sodium bicarbonate, | 8 | 5.5 |
| citric acid, lactic acid, 0.75%) | | |
| Dry Natural MI-322 (vinegar, sodium bicarbonate, | 10 | 5.5 |
| citric acid, lactic acid, 1.00%) | | |
| Dry Natural MI-322 (vinegar, sodium bicarbonate, | 11 | 5.48 |
| citric acid, lactic acid, 1.25%) | | |
| Dry Natural MI-322 (vinegar, sodium bicarbonate, | 13 | 5.45 |
| citric acid, lactic acid, 1.50%) | | |
| CP 0.33% | 9 | 5.57 |
| CP 0.50% | 12 | 5.57 |
| CP 0.75% | 23 | 5.58 |
| CP 1.00% | 32 | 5.59 |
| Nabitor ™ (cultured corn syrup, citric acid) 1.0% | 11 | 5.32 |
| Nabitor ™ (cultured corn syrup, citric acid) 1.4% | 19 | 5.22 |
| Control-No Additives | 6 | 5.61 |

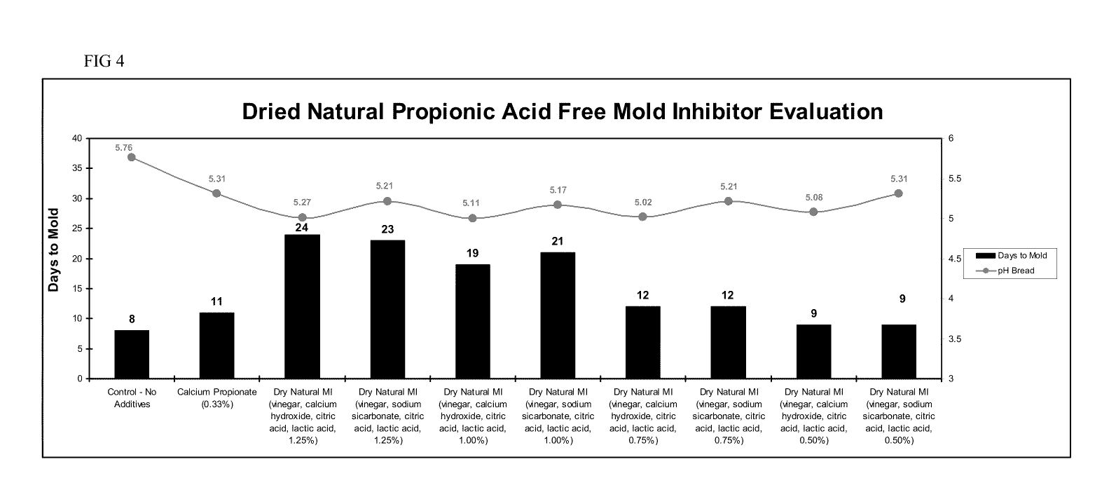

TABLE 9
Data shown in FIG. 4. FIG. 4 illustrates the anti-microbial effects of dried
propionic acid free Natural Mold Inhibitor compared to propionic acid based
calcium propionate when used in industry standard White Pan Bread
formulations. The data illustrates that the Dried Natural Mold Inhibitors
produced with sodium bicarbonate and calcium hydroxide are as effective
in inhibiting the rate of mold growth as compared to the industry standard
propionic acid based mold inhibitor, calcium propionate.

| | Days to | pH | Proof |
|---|---|---|---|
| Sample | Mold | Bread | Time |
| Control-No Additives | 8 | 5.76 | 51 |
| Calcium Propionate (0.33%) | 11 | 5.31 | 52 |
| Dry Natural MI (vinegar, calcium hydroxide, | 24 | 5.01 | 63 |
| citric acid, lactic acid, 1.25%) | | | |
| Dry Natural MI (vinegar, sodium bicarbonate, | 23 | 5.21 | 61 |
| citric acid, lactic acid, 1.25%) | | | |
| Dry Natural MI (vinegar, calcium hydroxide, | 19 | 5 | 58 |
| citric acid, lactic acid, 1.00%) | | | |
| Dry Natural MI (vinegar, sodium bicarbonate, | 21 | 5.17 | 58 |
| citric acid, lactic acid, 1.00%) | | | |
| Dry Natural MI (vinegar, calcium hydroxide, | 12 | 5.02 | 51 |
| citric acid, lactic acid, 0.75%) | | | |
| Dry Natural MI (vinegar, sodium bicarbonate, | 12 | 5.21 | 51 |
| citric acid, lactic acid, 0.75%) | | | |
| Dry Natural MI (vinegar, calcium hydroxide, | 9 | 5.08 | 49 |
| citric acid, lactic acid, 0.50%) | | | |
| Dry Natural MI (vinegar, sodium bicarbonate, | 9 | 5.31 | 51 |
| citric acid, lactic acid, 0.50%) | | | |

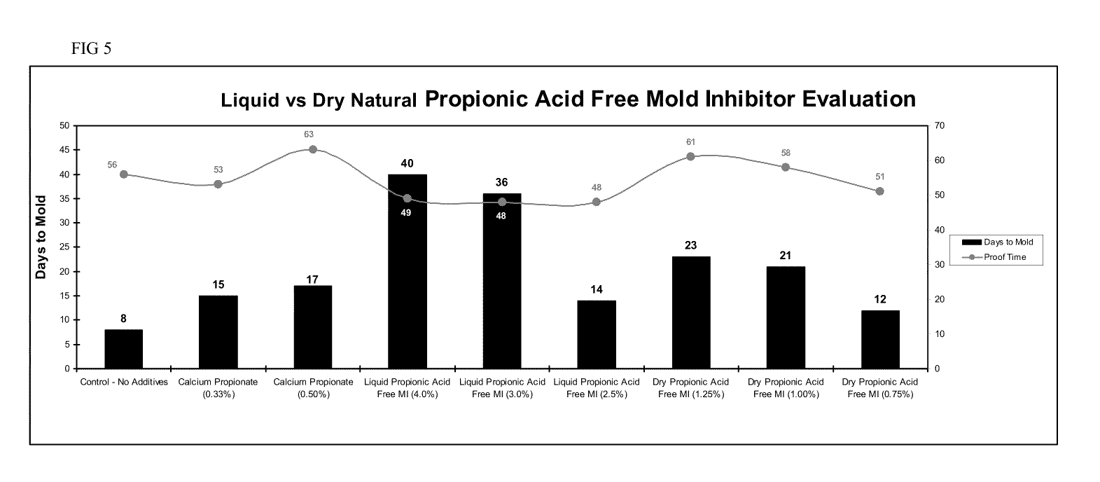

TABLE 10
Data shown in FIG. 5. FIG. 5 is a validation of previous anti-microbial data
of liquid and dried propionic acid free Natural Mold Inhibitor (sodium based)
compared to propionic acid based calcium propionate used in an industry
standard White Pan Bread formulation. The data illustrates that both the
propionic acid free Liquid and Dried Natural Mold Inhibitors produced with
vinegar, sodium bicarbonate, citric acid and lactic acid are as effective in
inhibiting the rate of mold growth as compared to the industry standard
propionic acid based mold inhibitor, calcium propionate.

| Sample | Days to Mold | Proof Time |
|---|---|---|
| Control-No Additives | 8 | 56 |
| Calcium Propionate (0.33%) | 15 | 53 |
| Calcium Propionate (0.50%) | 17 | 63 |
| Liquid Propionic Acid Free MI (4.0%) | 40 | 49 |
| Liquid Propionic Acid Free MI (3.0%) | 36 | 48 |
| Liquid Propionic Acid Free MI (2.5%) | 14 | 48 |
| Dry Propionic Acid Free MI (1.25%) | 23 | 61 |
| Dry Propionic Acid Free MI (1.00%) | 21 | 58 |
| Dry Propionic Acid Free MI (0.75%) | 12 | 51 |

What is claimed is:

1. A liquid composition for inhibiting mold growth on a baked product comprising
a. from about 50% to about 95% by weight of a natural acid, wherein said natural acid is provided in a solution of from about 0.1% to about 99%; and
b. from about 5% to about 80% by weight of a buffering agent.

2. The liquid composition of claim 1, wherein said natural acid is selected from acetic acid, lactic acid, citric acid, malic acid, tartaric acid, any other natural acid, or a combination thereof.

3. The liquid composition of claim 1, wherein said natural acid is selected from vinegar, naturally derived acetic acid, or a combination thereof.

4. The liquid composition of claim 1, wherein said natural acid is bacterially cultured, naturally derived, or a combination thereof.

5. The liquid composition of claim 1, wherein said buffering agent is selected from a natural calcium or sodium source.

6. The liquid composition of claim 1, wherein said buffering agent is selected from sodium carbonate, sodium bicarbonate, calcium hydroxide, calcium carbonate, any other natural buffering agent, or a combination thereof.

7. The liquid composition of claim 1, wherein said buffering agent maintains the pH of said composition at a pH of from about 4.0 to about 5.5.

8. The liquid composition of claim 1, wherein said liquid composition is substantially free of propionic acid or a salt of propionic acid.

9. The liquid composition of claim 1, wherein said liquid composition does not cause formation of propionic acid or a salt of propionic acid during a baking process.

10. A dry composition for inhibiting mold growth on a baked product comprising
a. a first component derived from a composition comprising
i. from about 70% to about 95% of a natural acid, wherein said natural acid is provided in a solution of from about 0.1% to about 99%; and
ii. from about 5% to about 30% of a buffering agent; and
b. a second component comprising from about 20% to about 50% of an acid selected from citric acid, malic acid, tartaric acid, lactic acid, any other natural acid, or a combination thereof.

11. The dry composition of claim 12, wherein said natural acid is selected from acetic acid, lactic acid, citric acid, malic acid, tartaric acid, any other natural acid, or a combination thereof.

12. The dry composition of claim 12, wherein said natural acid is selected from vinegar, naturally derived acetic acid, or a combination thereof.

13. The dry composition of claim 12, wherein said natural acid is bacterially cultured, naturally derived, or a combination thereof.

14. The dry composition of claim 12, wherein said buffering agent is selected from a natural calcium or sodium source.

15. The dry composition of claim 12, wherein said buffering agent is selected from sodium bicarbonate, calcium hydroxide, calcium carbonate, any natural buffering agent, or a combination thereof.

16. The dry composition of claim 12, wherein said buffering agent maintains the pH of said composition to a pH of from about 4.0 to about 5.5.

17. The dry composition of claim 12, wherein said liquid composition is substantially free of propionic acid or a salt of propionic acid.

18. The dry composition of claim 12, wherein said composition does not cause formation of propionic acid or a salt of propionic acid during a baking process.

19. The dry composition of claim 12, wherein said second component comprises a liquid, an agglomerate, encapsulate, paste, gel, extrudate, or a combination thereof.

20. The dry composition of claim 12, wherein said dry composition is a semi solid selected from a gel, paste, or combination thereof.

21. The dry composition of claim 12, wherein said dry composition is in the form selected from a powder, a granule, a pellet, or a mixture thereof.

22. The dry composition of claim 12, wherein said dry composition comprises less than about 10% moisture.

23. The dry composition of claim 12, wherein said buffering agent maintains the pH of said composition to a pH of from about 4.0 to about 5.5.

24. A method of inhibiting mold growth on a baked good, comprising the step of combining a composition according to claim 1 with one or more ingredients selected from flour, starch, salt, water, yeast, a biological leavening system, a chemical leavening system, sugar, or a combination thereof to form a raw bakery dough or batter.

25. A method of inhibiting mold growth on a baked good, comprising the step of combining a composition according to claim 12 with one or more ingredients selected from flour, starch, salt, water, yeast, a biological leavening system, a chemical leavening system, sugar, or a combination thereof to form a raw bakery dough or batter.

26. The method of claim 25, wherein said baked good is a gluten-free baked good.
